(19) United States
(12) Patent Application Publication
(10) Pub. No.: US 2007/0139335 A1
(43) Pub. Date: Jun. 21, 2007

(54) Liquid crystal display device having data memory units

(75) Inventors: Eddy Giing-Lii Chen, Miao-Li (TW); Sz-Hsiao Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,394

(22) Filed: Dec. 18, 2006

(30) Foreign Application Priority Data
Dec. 16, 2005 (CN) 200510120718.5

(51) Int. Cl. G09G 3/36

(52) U.S. Cl. 345/92

(57) ABSTRACT

An exemplary liquid crystal display device (200) includes: a first substrate, the first substrate including a parallel scan lines (201) and parallel data lines orthogonal to the scan lines (202); pixel electrodes (203); switches (211) each positioned near a crossing of a corresponding scan line and a corresponding data line, a first terminal of each switch being coupled to a scan line, a second terminal of the switch being coupled to a data line, and a third terminal of the switch being coupled to a corresponding pixel electrodes first data memory units (241), each of which outputs voltage signals to a corresponding pixel electrode during a time period in a frame; and second data memory units (242), each of which outputs voltage signals to the pixel electrode during another time period in the same frame.

### FIELD OF THE INVENTION

The present invention relates to liquid crystal display (LCD) devices, and more particularly to an LCD device having data memory units such that the LCD device is capable of displaying 64 gray scale levels in a static display mode.

### BACKGROUND

Nowadays, small LCD devices are more and more commonly used in portable electronic equipment, such as mobile phones, personal digital assistants (PDAs), and the like. Therefore, the issue of reducing power consumption of these kinds of LCD devices is becoming more important.

In order to reduce the power consumption of LCD devices, the LCD industry has developed a kind of technique in which the display status of an LCD device is divided into two modes. One of these is an active display mode, and the other is a static display mode. An example of the static display mode is the image shown on a mobile phone LCD when the mobile phone is in a call waiting status. In the active display mode, the operation of the LCD device is normal full operation. For example, the LCD device may be a thin-film transistor LCD (TFT-LCD) device. In the static display mode, the LCD device uses a static random access memory (SRAM) for supplying power to pixel regions, so as to reduce power consumption.

FIG. 4 is an abbreviated circuit diagram of a conventional active matrix LCD device 100. FIG. 5 is an enlarged circuit diagram of a sub pixel unit 140 of the active matrix LCD device 100. The active matrix LCD device 100 includes a glass first substrate (not shown), a glass second substrate (not shown) facing the first substrate, and a liquid crystal layer (not shown) sandwiched between the first substrate and the second substrate. The first substrate includes a plurality of parallel scan lines 101, a plurality of parallel data lines 102 orthogonal to the scan lines 101, a plurality of first thin-film transistors (TFTs) 111 each positioned near a crossing of a corresponding scan line 101 and a corresponding data line 102, a plurality of pixel electrodes 103, and a plurality of data memory units 104. The second substrate includes a common electrode 104 corresponding to the pixel electrodes 103.

A pixel electrode 103, the common electrode 104 facing the pixel electrode 103, liquid crystal molecules of the liquid crystal layer sandwiched between the two electrodes 103 and 104, a first TFT 111, and a data memory unit 141 cooperatively define a single sub pixel unit 140. The pixel electrode 103 and the common electrode 104 cooperatively form a capacitor 105.

A gate electrode (not labeled) of the first TFT 111 is electrically coupled to the corresponding scan line 101, and a source electrode (not labeled) of the first TFT 111 is electrically coupled to the corresponding data line 102. Further, a drain electrode (not labeled) of the first TFT 111 is electrically coupled to the corresponding pixel electrode 103.

The data memory unit 141 includes a second TFT 112, a third TFT 113, a first controlling terminal 121, a second controlling terminal 122, and an SRAM 131. A gate electrode (not labeled) of the second TFT 112 is electrically coupled to the first controlling terminal 121, and a source electrode (not labeled) of the second TFT 112 is electrically coupled to the corresponding pixel electrode 103. Further, a drain electrode (not labeled) of the second TFT 112 is electrically coupled to a first terminal 1310 of the SRAM 131. A gate electrode (not labeled) of the third TFT 113 is electrically coupled to the second controlling terminal 122, and a source electrode (not labeled) of the third TFT 113 is electrically coupled to a second terminal 1311 of the SRAM 131. Further, a drain electrode (not labeled) of the third TFT 113 is electrically coupled to the corresponding pixel electrode 103.

The SRAM 131 is used as a memory for storing data. In particular, voltage signals can be written into the SRAM 131. The SRAM 131 is also capable of outputting 0 volts and 3.3 volts, or 3.3 volts and 0 volts via the first and the second terminals 1310 and 1311 respectively, in different time periods. That is, if the first terminal 1310 outputs a low voltage signal of 0 volts, the second terminal 1311 then outputs a high voltage signal of 3.3 volts in another time periods; if the first terminal 1310 outputs a high voltage signal of 3.3 volts, the second terminal 1311 then outputs a low voltage signal of 0 volts.

The LCD device 100 is driven by an inversion method. FIG. 6 shows timing charts illustrating operation of the LCD device 100. V_{g}, V_{d}, and V_{com} respectively represent a scanning voltage signal applied to the scan lines 101, a data voltage signal applied to the data lines 102, and a voltage signal applied to the common electrode 104. V_{cont1} and V_{cont2} respectively represent a first controlling signal and a second controlling signal. Vₚ and V_{lC} respectively represent a voltage signal applied to the pixel electrodes 103 and a voltage signal for driving the liquid crystal molecules.

The LCD device 100 includes two display modes: active display mode and static display mode. The static display mode includes data writing mode and data reading mode.

During a first frame, i.e. a period between a point in time t₁ and a point in time t₃, the LCD device 100 is in the active display mode. When the time t is equal to t₁, a scanning voltage signal V_{g} is supplied to the gate electrode of the first TFT 111 via the scan line 101, so as to turn on the first TFT 111. The first controlling terminal 121 supplies a first controlling signal V_{cont1} to the gate electrode of the second TFT 112. The first controlling signal V_{cont1} is a low voltage signal, so then the second TFT 112 is turned off. A data voltage signal V_{d} is supplied to the pixel electrode 103 via the source and drain electrodes of the first TFT 111 and the data line 102. The data voltage signal V_{d} is a gray scale voltage. When the time t is equal to t₂, the first TFT 111 is turned off by turning off the supply of the scanning voltage V_{g}, whereupon the capacitor 105 maintains the gray scale voltage until the TFT 111 is turned on at t=t₃.

Similarly, during a second frame, i.e. a period between the time t₃ and a point in time t₅, the LCD device 100 is in the data writing mode of the static display mode. When t is equal to t₃, a scanning voltage signal V_{g} is supplied to the gate electrode of the first TFT 111 via the scan line 101, so as to turn on the first TFT 111. The first controlling terminal 121 supplies a first controlling signal V_{cont1} to the gate electrode of the second TFT 112. The first controlling signal V_{cont1} is a high voltage signal, so then the second TFT 112 is turned on. The second controlling terminal 122 supplies a second controlling signal V_{cont2} to the gate electrode of the third TFT 113. The second controlling signal V_{cont2} is a low voltage signal, so then the third TFT 113 is turned off. A data voltage signal V_{d} is supplied to the pixel electrode 103 via the source and drain electrodes of the first TFT 111 and the data line 102. The data voltage signal V_{d} is a low gray scale voltage. At the same time, the low gray scale voltage is written into the SRAM 131 via the source and drain electrodes of the second TFT 112. When the time t is equal to t₄, the first TFT 111 is turned off, whereupon the capacitor 105 maintains the low gray scale voltage.

During a third frame, i.e. a period between the time t₅ and a point in time t₆, the LCD device 100 is in the data reading mode of the static display mode. A voltage signal is supplied to the pixel electrode 103 via the second terminal 1311 of the SRAM 131. When t is equal to t₅, the first controlling terminal 121 supplies a first controlling signal V_{cont1} to the gate electrode of the second TFT 112. The first controlling signal V_{cont1} is a low voltage signal, so then the second TFT 112 is turned off. The second controlling terminal 122 supplies a second controlling signal V_{cont2} to the gate electrode of the third TFT 113. The second controlling signal V_{cont2} is a high voltage signal, so then the third TFT 113 is turned on. At the same time, a high voltage signal is outputted from the second terminal 1311 of the SRAM 131, and is supplied to the pixel electrode 103 via the source and drain electrodes of the third TFT 113.

During a fourth frame, i.e. a period between the time t₆ and a point in time t₇, the LCD device 100 is in the data reading mode of the static display mode. A voltage signal is supplied to the pixel electrode 103 via the first terminal 1310 of the SRAM 131. When t is equal to t₆, the first controlling terminal 121 supplies a first controlling signal V_{cont1} to the gate electrode of the second TFT 112. The first controlling signal V_{cont1} is a high voltage signal, so then the second TFT 112 is turned on. The second controlling terminal 122 supplies a second controlling signal V_{cont2} to the gate electrode of the third TFT 113. The second controlling signal V_{cont2} is a low voltage signal, so then the third TFT 113 is turned off. At the same time, a low voltage signal is outputted from the second terminal 1311 of the SRAM 131, and is supplied to the pixel electrode 103 via the source and drain electrodes of the second TFT 112.

While the LCD device 100 is in the data reading mode of the static display mode, a high or a low voltage signal outputted by the SRAM 131 is supplied to the pixel electrode 103, and the common electrode 104 is supplied a high or a low common voltage respectively in each frame. Therefore, the gray scale voltage for driving the liquid crystal molecules can be a positive high voltage, a negative high voltage, or zero voltage. When the gray scale voltage is a positive or negative high voltage, the sub pixel unit 140 is in a white state (on state). Moreover, when the gray scale voltage is zero voltage, the sub pixel unit 140 is in a black state (off state). That is, each sub pixel unit 140 of the LCD device 100 has a gray scale of 2 levels in the data reading mode of the static display mode.

Each of pixel units of the LCD device 100 includes three sub pixel units 140; and each sub pixel unit 140 can display a gray scale of 2 levels. Therefore, each pixel unit of the LCD device 100 can display a gray scale of 8 levels in a static display mode. However, the gray scale of 8 levels is rather limited, and the LCD device 100 is not considered to be capable of displaying rich and colorful images.

It is desired to provide an LCD device which can overcome the above-described deficiencies.

### SUMMARY

An exemplary liquid crystal display device includes a first substrate having a plurality of parallel scan lines; a plurality of parallel data lines substantially orthogonal to the scan lines; a plurality of pixel electrodes; a plurality of switches each positioned near a crossing of a corresponding one of the scan lines and a corresponding one of the data lines, a first terminal of each switch being electrically coupled to the corresponding scan line, a second terminal of the switch being electrically coupled to the corresponding data line, and a third terminal of the switch being electrically coupled to a corresponding one of the pixel electrodes; a plurality of first data memory units, each of which configured to have a voltage signal written thereinto and to output voltage signals to a corresponding one of the pixel electrodes during a time period in a frame; and a plurality of second data memory units, each of which configured to have a voltage signal written thereinto and to output voltage signals to the corresponding pixel electrode during another time period in the same frame; a second substrate facing the first substrate; and a liquid crystal layer sandwiched between the first substrate and the second substrate.

Advantages and novel features of the liquid crystal display device will become more apparent from the following detailed description when taken in conjunction with the accompanying drawings, in which:

### BRIEF DESCRIPTION OF THE DRAWINGS

FIG. 1 is an abbreviated circuit diagram of an LCD device according to an exemplary embodiment of the present invention;

FIG. 2 is an enlarged circuit diagram of one of sub pixels of the LCD device of FIG. 1;

FIG. 3 shows timing charts illustrating exemplary operation of the LCD device of FIG. 1;

FIG. 4 is an abbreviated circuit diagram of a conventional LCD device;

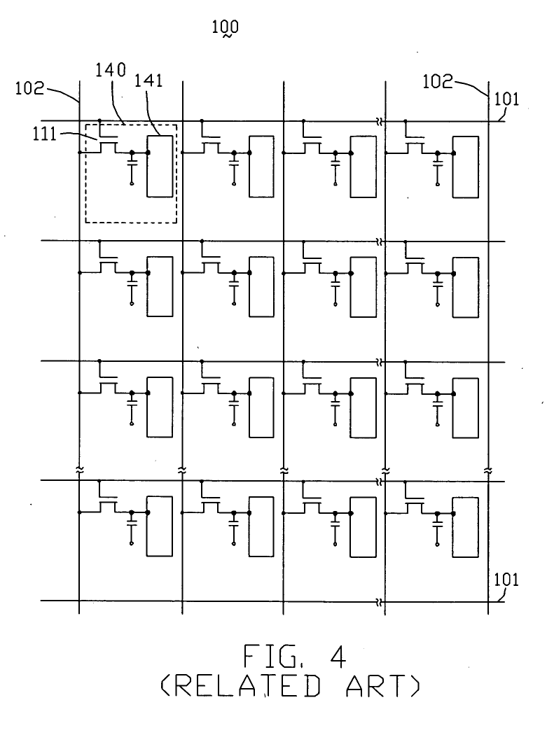

FIG. 5 is an enlarged circuit diagram of one of sub pixels of the LCD device of FIG. 4; and

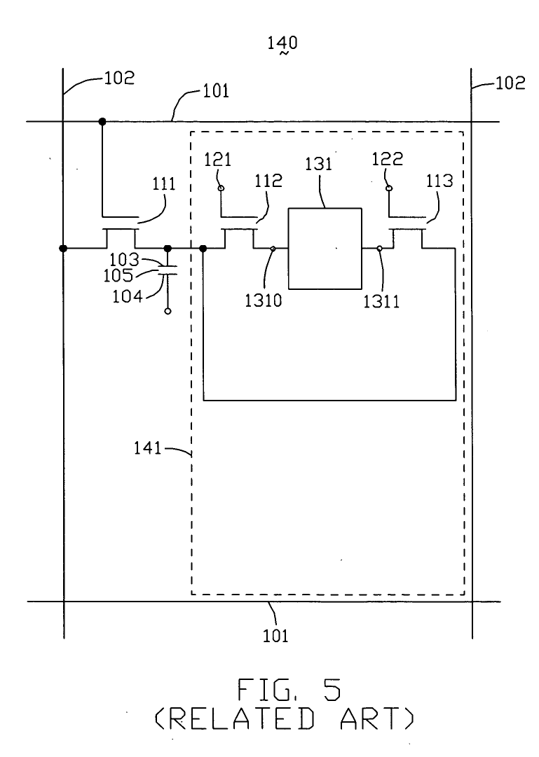

FIG. 6 shows timing charts illustrating operation of the LCD device of FIG. 4.

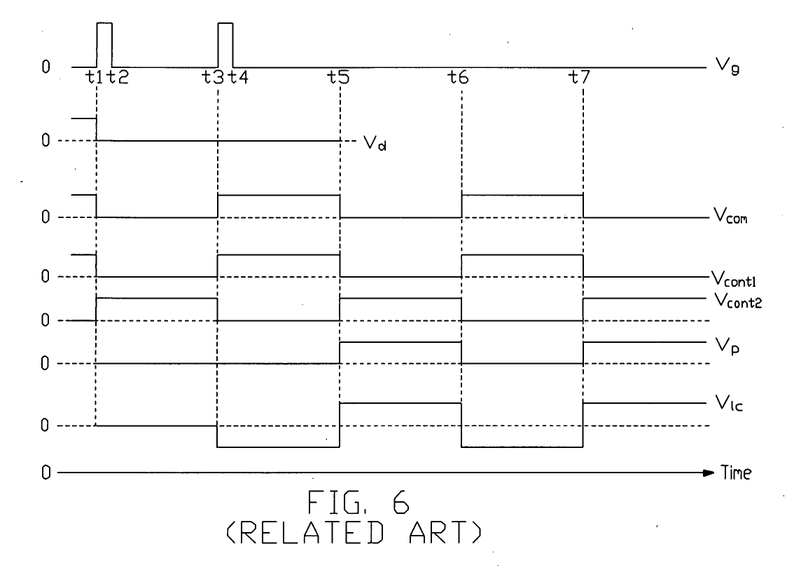

### DETAILED DESCRIPTION OF PREFERRED EMBODIMENTS

Reference will now be made to the drawings to describe preferred and exemplary embodiments of the present invention in detail.

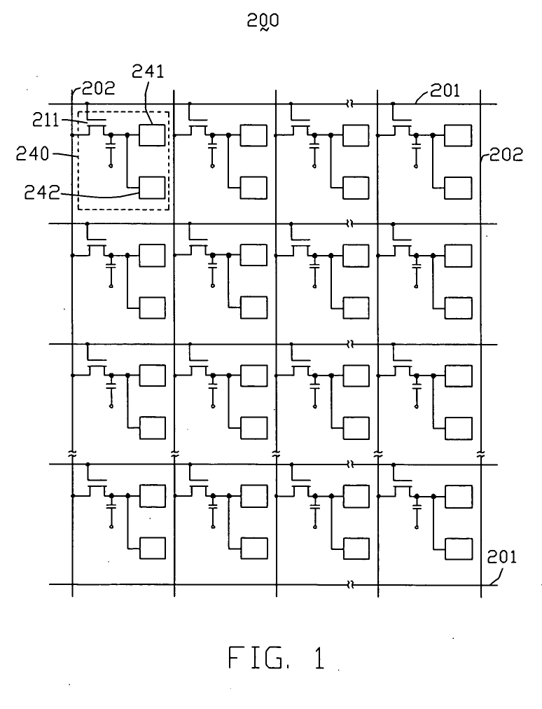

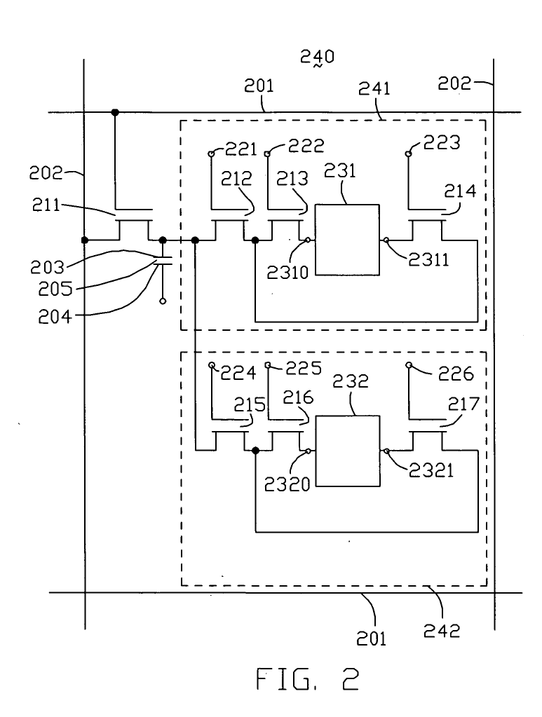

FIG. 1 is an abbreviated circuit diagram of an LCD device according to an exemplary embodiment of the present invention. FIG. 2 is an enlarged circuit diagram of one of sub pixel units of the LCD device. The LCD device 200 includes a glass first substrate (not shown), a glass second substrate (not shown) facing the first substrate, and a liquid crystal layer (not shown) sandwiched between the first substrate and the second substrate.

The first substrate includes a plurality of parallel scan lines 201, a plurality of parallel data lines 202 orthogonal to the parallel scan lines 201, a plurality of first thin-film transistors (TFTs) 211 each positioned near a crossing of a corresponding scan line 201 and a corresponding data line 202, a plurality of pixel electrodes 203, a plurality of first data memory units 241, and a plurality of second data memory units 242. The second substrate includes a common electrode 204 corresponding to the pixel electrodes 203.

A pixel electrode 203, a common electrode 204 facing the pixel electrode 203, liquid crystal molecules of the liquid crystal layer sandwiched between the two electrodes 203 and 204, a first TFT 211, a first data memory unit 241, and a second data memory unit 242 cooperatively define a single sub pixel unit 240. Each pixel electrode 203 and the common electrode 204 cooperatively form a capacitor 205.

A gate electrode (not labeled) of the first TFT 211 is electrically coupled to the scan line 201, and a source electrode (not labeled) of the first TFT 211 is electrically coupled to the data line 202. Further, a drain electrode (not labeled) of the first TFT 211 is electrically coupled to the corresponding pixel electrode 203.

The first data memory unit 241 includes a second TFT 212, a third TFT 213, a fourth TFT 214, a first controlling terminal 221, a second controlling terminal 222, a third controlling terminal 223, and a first static random access memory (SRAM) 231. A gate electrode (not labeled) of the second TFT 212 is electrically coupled to the first controlling terminal 221, and a source electrode (not labeled) of the second TFT 212 is electrically coupled to the corresponding pixel electrode 203. Further, a drain electrode (not labeled) of the second TFT 212 is electrically coupled to a gate electrode (not labeled) of the third TFT 213. A gate electrode (not labeled) of the third TFT 213 is electrically coupled to the second controlling terminal 222, and a drain electrode (not labeled) of the third TFT 213 is electrically coupled to a first terminal 2310 of the first SRAM 231. A gate electrode (not labeled) of the fourth TFT 214 is electrically coupled to the third controlling terminal 223, and a source electrode (not labeled) of the fourth TFT 214 is electrically coupled to a second terminal 2311 of the first SRAM 231. Further, a drain electrode (not labeled) of the fourth TFT 214 is electrically coupled to the drain electrode of the second TFT 212.

The second data memory unit 242 includes a fifth TFT 215, a sixth TFT 216, a seventh TFT 217, a fourth controlling terminal 224, a fifth controlling terminal 225, a sixth controlling terminal 226, and a second SRAM 232. A gate electrode (not labeled) of the fifth TFT 215 is electrically coupled to the fourth controlling terminal 224, and a source electrode (not labeled) of the fifth TFT 215 is electrically coupled to the corresponding pixel electrode 203. Further, a drain electrode (not labeled) of the fifth TFT 215 is electrically coupled to a gate electrode (not labeled) of the sixth TFT 216. A gate electrode (not labeled) of the sixth TFT 216 is electrically coupled to the fifth controlling terminal 225, and a drain electrode (not labeled) of the sixth TFT 216 is electrically coupled to a first terminal 2320 of the second SRAM 232. A gate electrode (not labeled) of the seventh TFT 217 is electrically coupled to the sixth controlling terminal 226, and a source electrode (not labeled) of the seventh TFT 217 is electrically coupled to a second terminal 2321 of the second SRAM 232. Further, a drain electrode (not labeled) of the seventh TFT 217 is electrically coupled to the drain electrode of the fifth TFT 215.

The first SRAM 231 is used as a memory for storing data. In particular, voltage signals can be written into the first SRAM 231. The first SRAM 231 is also capable of outputting 0 volts and 3.3 volts, or 3.3 volts and 0 volts via the first and the second terminals 2310 and 2311 respectively, in different time periods. That is, if the first terminal 2310 outputs a low voltage signal of 0 volts, the second terminal 2311 then outputs a high voltage signal of 3.3 volts in another time period; and if the first terminal 2310 outputs a high voltage signal of 3.3 volts, the second terminal 2311 then outputs a low voltage signal of 0 volts.

The second SRAM 232 is also used as a memory for storing data, and the process of operation of the second SRAM 232 is similar to that of the first SRAM 231. The first through seventh TFTs 211 to 217 can be made of polysilicon.

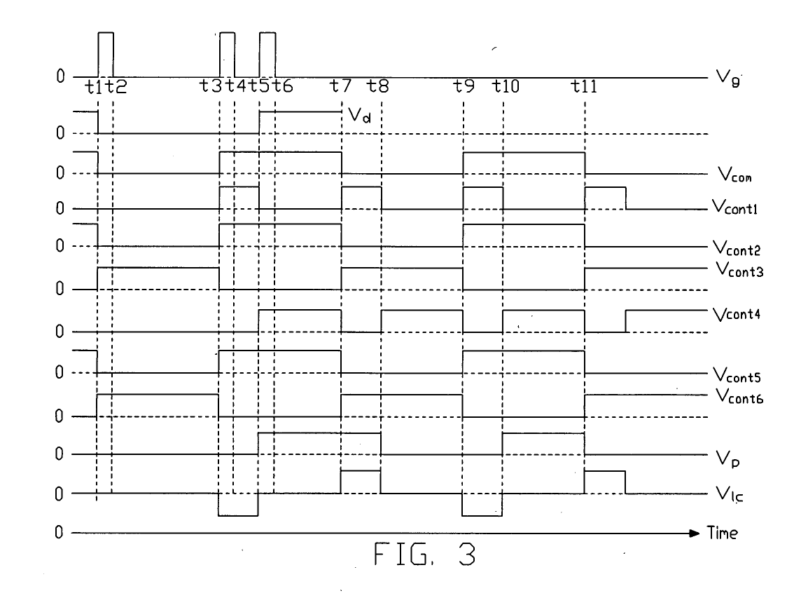

The LCD device 200 is driven by an inversion method. FIG. 3 shows timing charts illustrating operation of the LCD device 200. V_{g}, V_{d}, and V_{com} respectively represent a scanning voltage signal applied to the scan lines 201, a data voltage signal applied to the data lines 202, and a voltage signal applied to the common electrode 204. Vₚ and V_{lc} respectively represent a voltage signal applied to the pixel electrodes 103 and a voltage signal for driving the liquid crystal molecules. V_{cont1}, V_{cont2}, V_{cont3}, V_{cont4}, V_{cont5}, and V_{cont6} respectively represent a first, a second, a third, a fourth, a fifth, and a sixth controlling signals.

The LCD device 200 includes two display modes: an active display mode and a static display mode. The static display mode includes a data writing mode and a data reading mode.

During a first frame, i.e. a period between a time t₁ and a time t₃, the LCD device 200 is in the active display mode. When the time t is equal to t₁, a scanning voltage signal V_{g} is supplied to the gate electrode of the first TFT 211 via the scan line 201, so as to turn on the first TFT 211. The first controlling terminal 221 and the fourth controlling terminal 224 respectively supply a first controlling signal V_{cont1} and a fourth controlling signal V_{cont4} to the gate electrodes of the second TFT 212 and fifth TFT 215. The first and fourth controlling signals V_{cont1} and V_{cont4} are low voltage signals, so then the second TFT 212 and the fifth TFT 215 are turned off. A data voltage signal V_{d} is supplied to the pixel electrode 203 via the source and drain electrodes of the first TFT 211 and the data line 202. The data voltage signal V_{d} is a gray scale voltage. When the time t is equal to t₂, the first TFT 211 is turned off by turning off the supply of the scanning voltage V_{g}, whereupon the capacitor 205 maintains the gray scale voltage until the TFT 211 is turned on at t=t₃.

The second, the third and the fourth frames are respectively divided into two frame periods. In each of these frames, the first one-third period of time of the frame is taken as the first frame period, and the subsequent two-thirds period of time of the frame is taken as the second frame period.

During a second frame, i.e. a period between a time t₃ and a time t₇, the LCD device 200 is in the data writing mode of the static display mode.

During the first frame period of the second frame, i.e. a period between a time t₃ and a time t₅, a low voltage signal is written into the first SRAM 231. When t is equal to t₃, a scanning voltage signal V_{g} is supplied to the gate electrode of the first TFT 211 via the scan line 201, so as to turn on the first TFT 211. The first controlling terminal 221 and the second controlling terminal 222 respectively supply a first controlling signal V_{cont1} and a second controlling signal V_{cont2} to the gate electrodes of the second TFT 212 and the third TFT 213. The first and second controlling signals V_{cont1} and V_{cont2} are high voltage signals, so then the second TFT 212 and the third TFT 213 are turned on. The third controlling terminal 223 and the fourth controlling terminal 224 respectively supply a third controlling signal V_{cont3} and a fourth controlling signal V_{cont4} to the gate electrodes of the fourth TFT 214 and the fifth TFT 215. The third and fourth controlling signals V_{cont3} and V_{cont4} are low voltage signals, so then the fourth TFT 214 and the fifth TFT 215 are turned off. A data voltage signal V_{d} is supplied to the pixel electrode 203 via the source and drain electrodes of the first TFT 211 and the data line 202. The data voltage signal V_{d} is a low gray scale voltage. At the same time, the low gray scale voltage is also written into the first SRAM 231 via the source and drain electrodes of the second TFT 212 and the third TFT 213. When the time t is equal to t₄, the first TFT 211 is turned off, whereupon the capacitor 205 maintains the low gray scale voltage until the TFT 211 is turned on at t=t₅.

During the second frame period of the second frame, i.e. a period between a time t₅ and a time t₇, a high voltage signal is written into the second SRAM 232. When t is equal to t₅, a scanning voltage signal V_{g} is supplied to the gate electrode of the first TFT 211 via the scan line 201, so as to turn on the first TFT 211. The first controlling terminal 221 and the sixth controlling terminal 226 respectively supply a first controlling signal V_{cont1} and a sixth controlling signal V_{cont6} to the gate electrodes of the second TFT 212 and the seventh TFT 217. The first and seventh controlling signals V_{cont1} and V_{cont6} are low voltage signals, so then the second TFT 212 and the seventh TFT 217 are turned off. The fourth controlling terminal 224 and the fifth controlling terminal 225 respectively supply a fourth controlling signal V_{cont4} and a fifth controlling signal V_{cont5} to the gate electrodes of the fifth TFT 215 and the sixth TFT 216. The fourth and fifth controlling signals V_{cont4} and V_{cont5} are high voltage signals, so then the fifth TFT 215 and the sixth TFT 216 are turned on. A data voltage signal V_{d} is supplied to the pixel electrode 203 via the source and drain electrodes of the first TFT 211 and the data line 202. The data voltage signal V_{d} is a high gray scale voltage. At the same time, the high gray scale voltage is also written into the second SRAM 232 via the source and drain electrodes of the fifth TFT 215 and the sixth TFT 216. When the time t is equal to t₆, the first TFT 211 is turned off, whereupon the capacitor 205 maintains the high gray scale voltage.

During a third and a fourth frames, i.e. a period between a time t₇ and a time t₁₁, the LCD device 200 is in the data reading mode of the static display mode.

During the first frame period of the third frame, i.e. a period between a time t₇ and a time t₈, the first SRAM 231 outputs a voltage signal to the pixel electrode 203 via the second terminal 2311. When t is equal to t₇, the first controlling terminal 221 and the third controlling terminal 223 respectively supply a first controlling signal V_{cont1} and a third controlling signal V_{cont3} to the gate electrodes of the second TFT 212 and the fourth TFT 214. The first and third controlling signals V_{cont1} and V_{cont3} are high voltage signals, so then the second TFT 212 and the fourth TFT 214 are turned on. The second controlling terminal 222 and the fourth controlling terminal 224 respectively supply a second controlling signal V_{cont2} and a fourth controlling signal V_{cont4} to the gate electrodes of the third TFT 213 and the fifth TFT 215. The second and fourth controlling signals V_{cont2} and V_{cont4} are low voltage signals, so then the third TFT 213 and the fifth TFT 215 are turned off. At the same time, a high voltage signal is outputted from the second terminal 2311 of the first SRAM 231, and is supplied to the pixel electrode 203 via the source and drain electrodes of the fourth TFT 214 and the second TFT 212.

During the second frame period of the third frame, i.e. a period between a time t₈ and a time t₉, the second SRAM 232 outputs a voltage signal to the pixel electrode 203 via the second terminal 2321. When t is equal to t₈, the first controlling terminal 221 and the fifth controlling terminal 225 respectively supply a first controlling signal V_{cont1} and a fifth controlling signal V_{cont5} to the gate electrodes of the second TFT 212 and the sixth TFT 216. The first and fifth controlling signals V_{cont1} and V_{cont5} are low voltage signals, so then the second TFT 212 and the sixth TFT 216 are turned off. The fourth controlling terminal 224 and the sixth controlling terminal 226 respectively supply a fourth controlling signal V_{cont4} and a sixth controlling signal V_{cont6} to the gate electrodes of the fifth TFT 215 and the seventh TFT 217. The fourth and sixth controlling signals V_{cont4} and V_{cont6} are high voltage signals, so then the fifth TFT 215 and the seventh TFT 217 are turned on. At the same time, a low voltage signal is outputted from the second terminal 2321 of the second SRAM 232, and is supplied to the pixel electrode 203 via the source and drain electrodes of the seventh TFT 217 and the fifth TFT 215.

During the first frame period of the fourth frame, i.e. a period between a time t₉ and a time t₁₀, the first SRAM 231 outputs a voltage signal to the pixel electrode 203 via the second terminal 2310. When t is equal to t₉, the first controlling terminal 221 and the second controlling terminal 222 respectively supply a first controlling signal V_{cont1} and a second controlling signal V_{cont2} to the gate electrodes of the second TFT 212 and the third TFT 213. The first and second controlling signals V_{cont1} and V_{cont2} are high voltage signals, so then the second TFT 212 and the third TFT 213 are turned on. The third controlling terminal 223 and the fourth controlling terminal 224 respectively supply a third controlling signal V_{cont3} and a fourth controlling signal V_{cont4} to the gate electrodes of the fourth TFT 214 and the fifth TFT 215. The third and fourth controlling signals V_{cont3} and V_{cont4} are low voltage signals, so then the fourth TFT 214 and the fifth TFT 215 are turned off. At the same time, the low voltage signal is outputted from the first terminal 2310 of the first SRAM 231, and is supplied to the pixel electrode 203 via the source and drain electrodes of the third TFT 213 and the second TFT 212.

During the second frame period of the third frame, i.e. a period between a time t₁₀ and a time t₁₁, the second SRAM 232 outputs a voltage signal to the pixel electrode 203 via the first terminal 2320. When t is equal t₁₀, the first controlling terminal 221 and the sixth controlling terminal 226 respectively supply a first controlling signal V_{cont1} and a sixth controlling signal V_{cont6} to the gate electrodes of the second TFT 212 and the seventh TFT 217. The first and sixth controlling signals V_{cont1} and V_{cont6} are low voltage signals, so then the second TFT 212 and the seventh TFT 217 are turned off. The fourth controlling terminal 224 and the fifth controlling terminal 225 respectively supply a fourth controlling signal V_{cont4} and a fifth controlling signal V_{cont5} to the gate electrodes of the fifth TFT 215 and the sixth TFT 216. The fourth and fifth controlling signals V_{cont4} and V_{cont5} are high voltage signals, so then the fifth TFT 215 and the sixth TFT 216 are turned on. At the same time, a high voltage signal is outputted from the first terminal 2320 of the second SRAM 232, and is supplied to the pixel electrode 203 via the source and drain electrodes of the sixth TFT 216 and the fifth TFT 215.

Each sub pixel unit 240 of the LCD device 200 includes two data memory units 241 and 242. When the LCD device 200 is in the data reading mode of the static display mode, the data memory units 241 and 242 respectively output a high or a low voltage signal to the pixel electrode 203 in each first frame period and each second frame period. A high or a low voltage signal is supplied to the common electrode 204 during each frame. Therefore, the gray scale voltage for driving the liquid crystal molecules can be a high positive voltage, a high negative voltage, or zero voltage during each first frame period and each second frame period. When the gray scale voltage is zero voltage in a first frame period and a second frame period of a frame, the sub pixel unit 240 displays a first gray scale. When the gray scale voltage is a high voltage in a first frame period and a zero voltage in a second frame period of a frame, the sub pixel unit 240 displays a second gray scale. When the gray scale voltage is zero voltage in a first frame period and a high voltage in a second frame period of a frame, the sub pixel unit 240 displays a third gray scale. When the gray scale voltages are high voltages in a first and a second frame periods of a frame, the sub pixel unit 240 displays a fourth gray scale.

Each of pixel units of the LCD device 200 includes three sub pixel unit 240, and each sub pixel unit 240 can display a gray scale of 4 levels. Therefore, each pixel unit of the LCD device 200 can display a gray scale of 64 levels in a static display mode. Therefore the LCD device 200 can display rich and colorful images.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A liquid crystal display device, comprising:
a first substrate comprising:
a plurality of parallel scan lines;
a plurality of parallel data lines substantially orthogonal to the scan lines;
a plurality of pixel electrodes;
a plurality of switches each positioned near a crossing of a corresponding one of the scan lines and a corresponding one of the data lines, a first terminal of each switch being electrically coupled to the corresponding scan line, a second terminal of the switch being electrically coupled to the corresponding data line, and a third terminal of the switch being electrically coupled to a corresponding one of the pixel electrodes;
a plurality of first data memory units, each of which configured to have a voltage signal written thereinto and to output voltage signals to a corresponding one of the pixel electrodes during a time period in a frame; and
a plurality of second data memory units, each of which configured to have a voltage signal written thereinto and to output voltage signals to the corresponding pixel electrode during another time period in the same frame;
a second substrate facing the first substrate; and
a liquid crystal layer sandwiched between the first substrate and the second substrate.

2. The liquid crystal display device as claimed in claim 1, wherein each of the first and second data memory units comprises a first thin film transistor, a second thin film transistor, a third thin film transistor, a first controlling terminal, a second controlling terminal, a third controlling terminal, and an access memory, a gate electrode of the first thin film transistor is electrically coupled to the first controlling terminal, and a source electrode of the first thin film transistor is electrically coupled to the corresponding pixel electrode, a drain electrode of the first thin film transistor is electrically coupled to a source electrode of the second thin film transistor, a gate electrode of the second thin film transistor is electrically coupled to the second controlling terminal, and a drain electrode of the second thin film transistor is electrically coupled to a terminal of the access memory, a gate electrode of the third thin film transistor is electrically coupled to the third controlling terminal, and a source electrode of the third thin film transistor is electrically coupled to another terminal of the access memory, and a drain electrode of the third thin film transistor is electrically coupled to the drain electrode of the first thin film transistor.

3. The liquid crystal display device as claimed in claim 2, wherein the access memory of each of the first and second data memory units is a static random access memory, which is capable of written voltage signals thereinto and outputting a voltage signal greater than or equal to zero volts.

4. The liquid crystal display device as claimed in claim 1, wherein each of the switches is a thin film transistor.

5. The liquid crystal display device as claimed in claim 1, wherein the second substrate comprises a common electrode corresponding to the pixel electrodes.

6. The liquid crystal display device as claimed in claim 3, wherein when a frame is divided into a first frame period and a second frame period, one of the first and second static random access memories outputs a voltage signal to the pixel electrode during the first frame period and the second frame period, respectively.

7. The liquid crystal display device as claimed in claim 6, wherein voltage signals are written into the first and second static random access memories during the first and second frame periods, respectively.

8. The liquid crystal display device as claimed in claim 6, wherein a gray scale voltage is supplied to the pixel electrode via the data lines during the frame.

9. The liquid crystal display device as claimed in claim 6, wherein the first one-third period of time of the frame is the first frame period, and the subsequent two-thirds period of time of the frame is the second frame period.

10. A liquid crystal display device, comprising:
a first substrate comprising:
a plurality of parallel scan lines;
a plurality of parallel data lines substantially orthogonal to the scan lines;
a plurality of pixel units defined by the intersected scan lines and data lines; and
a TFT having two ports respectively electrically connected to the corresponding data line and scan line, and a third port electrically connected to a capacitor; wherein
said pixel unit further includes a pair of data memory units in a parallel arrangement.
